(19) United States
(12) Patent Application Publication
(10) Pub. No.: US 2006/0119782 A1
(43) Pub. Date: Jun. 8, 2006

(54) Color cholesteric liquid crystal display and its method thereof

(76) Inventors: Yi-An Sha, Taipei City (TW); Hsing-Lung Wang, Ping Jen City (TW); Chi-Chang Liao, Tai Nan City (TW); Chih-Chiang Lu, Hsin Chu City (TW); Jau-Min Ding, Taipei City (TW)

Correspondence Address: RABIN & BERDO, P.C.;Suite 500, 1101 14 Street, N.W., Washington, DC, 20005, US

(21) Appl. No.: 11/140,949

(22) Filed: Jun. 1, 2005

(30) Foreign Application Priority Data
Dec. 7, 2004 (TW) 93137856

(51) Int. Cl. C09K 19/02

(52) U.S. Cl. 349/175

(57) ABSTRACT

The present invention describes a color cholesteric liquid crystal display and a method of making the same that overcomes the complicated manufacturing process, the difficulty of aligning the panel and designing the electrodes, and the complicated driving method of a prior art color cholesteric liquid crystal display. The invention integrates an ink-jet method with a polymerization method and uses a cholesteric liquid crystal for a simple ink-jet process. This technology can make a color cholesteric liquid crystal display having dual steady states. In addition, the technology can be used for the manufacture of color cholesteric liquid crystal displays.

### BACKGROUND OF THE INVENTION

1. Field of the Invention

The present invention relates to a color cholesteric liquid crystal display and a method thereof, and more particularly to a color cholesteric liquid crystal display having dual steady states and made by using an ink-jet method in conjunction with ultraviolet ray exposures and cholesteric liquid crystals, and serving as a flexible color cholesteric liquid crystal display.

2. Description of Related Art

In recent years, flexible displays, electronic paper and electronic books have been developed at a fast pace, and the display media for these products include liquid crystal displays, electrophoresis displays, electrochromic displays and electrolytic deposition displays. In an application of electronic paper, a cholesteric liquid crystal is compared with other display media, and both the brightness and contrast of the cholesteric liquid crystal have a better evaluation while the cholesteric liquid crystal has an advantage of being driven and produced easily.

In the past, two common methods have been used to achieve a full-color cholesteric liquid crystal display. The first one uses a three-layer cholesteric structure, which stacks three layers of different colored reflective cholesteric liquid crystals and goes with a different driving method, such that the display can produce reflections of different colors. The disadvantages of the three-layer stacked structure reside in the difficulty of aligning the panel or designing the electrodes, and it is difficult to bend the structure. The second method uses a single layer cholesteric structure, which utilizes a chiral agent decomposable by light to mix with a cholesteric liquid crystal, and adjusts the illumination condition of external ultraviolet rays to destroy and/or reduce the chiral agent content in a single region, so as to achieve the single layer multicolor effect. However, the reliability of such device is not as good and is easily affected by the conditions of external environment, and thus it is necessary to add an ultraviolet-resistant layer for protection.

As to prior arts, U.S. Pat. No. 6,356,323, entitled “Color display using cholesteric liquid crystals”, discloses a color display using a cholesteric liquid. Referring to FIG. 1, a view of a prior art cholesteric color liquid crystal display structure is depicted. The structure comprises a light absorbing layer 10, a clear flexible substrate 12, a first conductor 14, a second conductor 16, a third conductor 18, a fourth conductor 20, a fifth conductor 22, a first light modulating layer 24, a second light modulating layer 26 and a third modulating layer 28.

U.S. Pat. No. 5,949,513, entitled “Methods of manufacturing multi-color liquid crystal displays using in situ mixing techniques”, discloses an instant mixing manufacturing method for multi-color liquid crystal displays. In FIG. 2, a schematic view of a multi-color liquid crystal display structure according to a prior art instant mixing technology is illustrated. The structure comprises a first substrate 30, a second substrate 32, a first twist agent 34, a second twist agent 36, an overall interstice 38 and a driver circuitry 40.

The aforementioned patented technology requires the processes of printing the first twist agent 34 and/or the second twist agent 36 onto a defined position, and then introducing cholesteric liquid crystals into it. Such patent emphasizes color cholesterol and the printing technology to produce multi-color liquid crystal display.

U.S. Pat. No. 6,331,884, entitled “Method of making a liquid crystal device”, discloses a method of using liquid crystal materials to make a liquid crystal device. In FIG. 3, a schematic view of the manufacturing process. of making a liquid crystal device according to a prior art is illustrated. The device comprises a plurality of liquid crystal materials 50, a plurality of resin partitions 52, a first substrate 54, a second substrate 56, a plurality of conductive films 58, a plurality of insulating films 60, a plurality of interstitial pillars 62 and a light absorbing layer 64.

However, the aforementioned method of making a liquid crystal device disclosed in U.S. Pat. No. 6,331,884 has the shortcomings of requiring pre-coating a resin monomer onto a plurality of insulating films 60 and spraying a plurality of liquid crystal materials 50, and then carrying out the exposure process after covering the second substrate 56 to form a plurality of resin partitions 52. The interstitial thickness between components and the manufacturing process cannot be controlled easily, and thus the required drive voltage is higher and the image effect is not as good.

### SUMMARY OF THE INVENTION

Therefore, it is a primary objective of the present invention to provide a method of making a display device by using an ink-jet method together with an ultraviolet ray exposure and cholesteric liquid crystals. The simple and easy ink-jet process is used to produce a color cholesteric liquid crystal display having dual steady states, and the display device can serve as a flexible color cholesteric liquid crystal display.

To achieve the foregoing objective, the present invention proposes a method of making a color cholesteric liquid crystal display, which comprises the steps of preparing a plurality of partition structures on a first electrode layer of a lower substrate; coating a plurality of cholesteric liquid crystals and a solution layer mixed with a polymer monomer between the partition structures; forming a plurality of cap layers on the cholesteric liquid crystal layer; and carrying out the process of combining an upper substrate having a second electrode layer with a lower substrate.

Further, the present invention also proposes a color cholesteric. liquid crystal display, which comprises a second electrode layer and a lower substrate having a first electrode layer, a plurality of partition structures dispersed on the lower substrate, a plurality of cholesteric liquid crystals dispersed between the partition structures, a plurality of cap layers dispersed on the cholesteric liquid crystals, and a plurality of electrode layers dispersed on the cap layers.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a view of a conventional prior color display structure having three layers of cholesteric liquid crystals;

FIG. 2 is a view of a conventional prior multi-color liquid crystal display structure using an instant mixing technology;

FIG. 3 is a view of a method and a manufacturing process of manufacturing a conventional prior liquid device;

FIGS. 4A to 4D are schematic views of a color cholesteric liquid crystal display according to a first preferred embodiment of the present invention; and

FIGS. 5A to 5D are schematic views of a color cholesteric liquid crystal display according to a second preferred embodiment of the present invention.

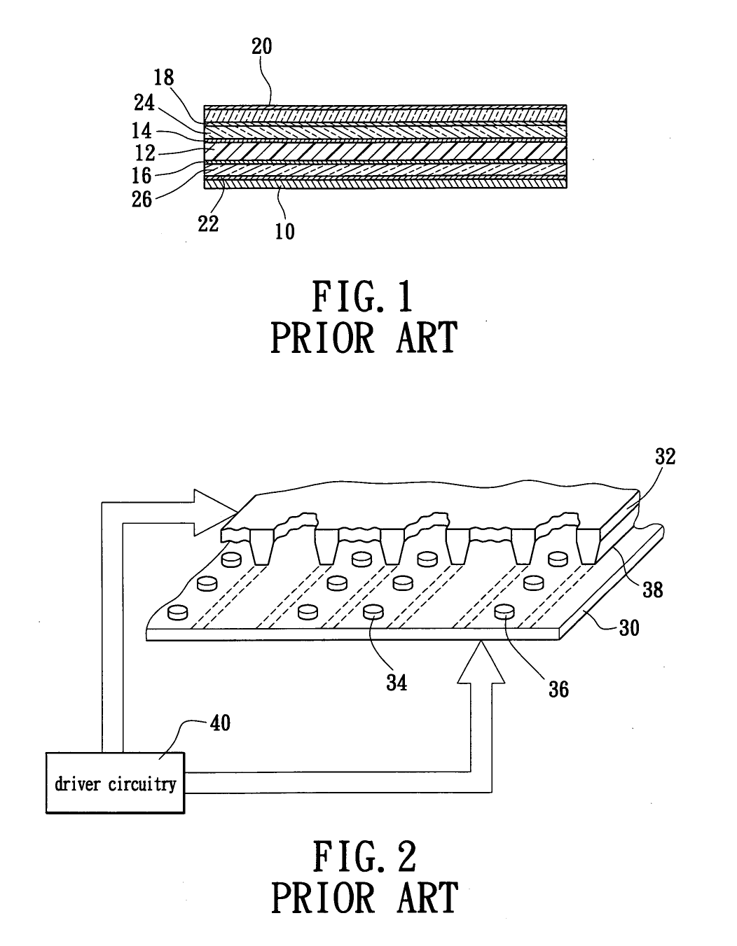

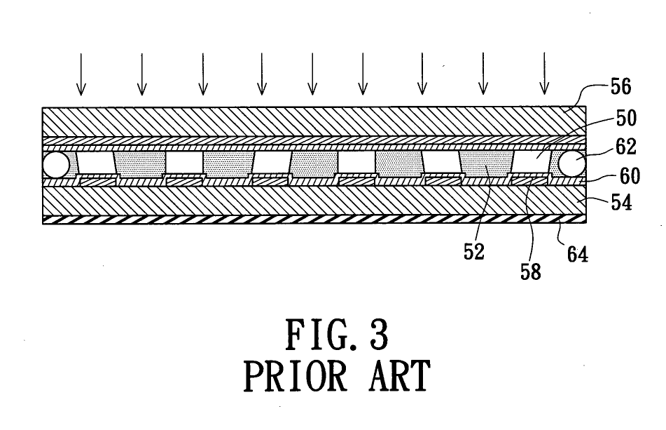

### DETAILED DESCRIPTION OF THE PREFERRED EMBODIMENTS

The present invention uses an ink-jet method to coat cholesteric liquid crystals of three different colors in a defined region so as to achieve a single layer color cholesteric liquid crystal display.

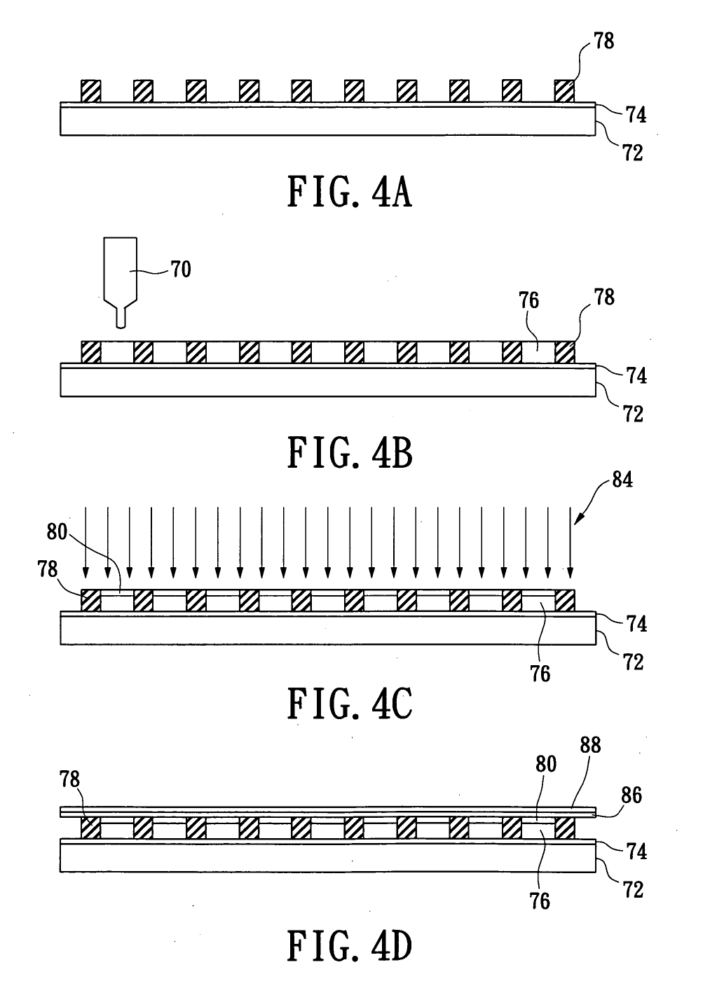

Referring to FIGS. 4A to 4D, schematic views of making a color cholesteric liquid crystal display by an ink-jet method according to a first preferred embodiment of the present invention is illustrated. In FIG. 4A, a plurality of partition structures 78 is produced on a first electrode layer 74 of a lower substrate 72. The partition structures are made by a yellow light, a screen printing, a die-casting and/or an ink-jet process. The lower substrate 72 uses a glass substrate or a plastic substrate and comprises an active or a passive driver circuit. The first electrode layer uses an organic conductive material or an inorganic conductive material. The partition structure is made of a polymer material, and the polymer material contains a pigment. The manufacturing process further comprises a step of coating an alignment layer on a first electrode layer of a lower substrate, where the alignment layer uses polyvinyl alcohol, polyimide, polyamide, nylon, silicon dioxide, micro trench or lecithin.

Referring to FIG. 4B, a plurality of cholesteric liquid crystals and polymer monomers or a solution 76 of mixing polymers with pre-polymers is coated between the partition structures, and the cholesteric liquid crystal is made of a cholesteric liquid crystal material and uses a mixed material of nematic liquid crystals and chiral agents. The cholesteric liquid crystals are liquid crystals with a plurality of different colors, and the reflective wavelength of the cholesteric liquid crystal ranges from 400 nm to 800 nm. The cholesteric liquid crystal further contains a pigment. The partition structures are made of a polymer material and such polymer material further contains a pigment. The coating process is achieved by an ink-jet head and an ink-jet method. In FIG. 4C, a plurality of caps 80 is formed by carrying out a phase separation in an ultraviolet ray exposure. The ultraviolet ray exposure is carried out by directly projecting the ultraviolet rays and the caps serves as a polymer protective layer.

Referring to FIG. 4D, the process of combining an upper substrate 88 having a first electrode layer 86 with the lower substrate is carried out. The upper substrate uses a glass substrate or a plastic substrate. The second electrode layer uses an inorganic conductive material or an organic conductive material and comprises an active or a passive driver circuit.

The aforementioned first preferred embodiment forms a partition structure by applying a yellow light, a screen printing, a die-casting and/or an ink-jet process on the lower substrate having an electrode layer, and then introduces a plurality of cholesteric liquid crystals of different reflective colors and a solution mixed by a polymer monomer or a polymer prepolymer. These cholesteric liquid crystals reflect three colors of the RGB, and then an ultraviolet ray exposure is used to form a cap of a polymer protective layer. The polymer protective layer is used to avoid a mixed color. Then, the upper and lower substrates are combined by gluing or direct pressing. The upper substrate has an electrode layer, and the electrode layer is made of an inorganic conductive material or an organic conductive material. The upper and lower substrates comprise an active driver circuit or a passive driver circuit.

In actual practices, the liquid crystal is exposed to ultraviolet rays once or twice. The first exposure is to form the polymer protective layer, and the second exposure is for the combining process. The liquid crystal is made of a cholesteric liquid crystal material, and the reflective wavelength of the cholesteric liquid crystal includes visible light and ranges from 400 nm to 800 nm. The advantage of this embodiment for making a color cholesteric liquid crystal display by an ink-jet method is that the structure is prepared first, and then the cholesteric liquid crystals are introduced one by one. The structure is more stable, has a low drive voltage, and enjoys an excellent image effect.

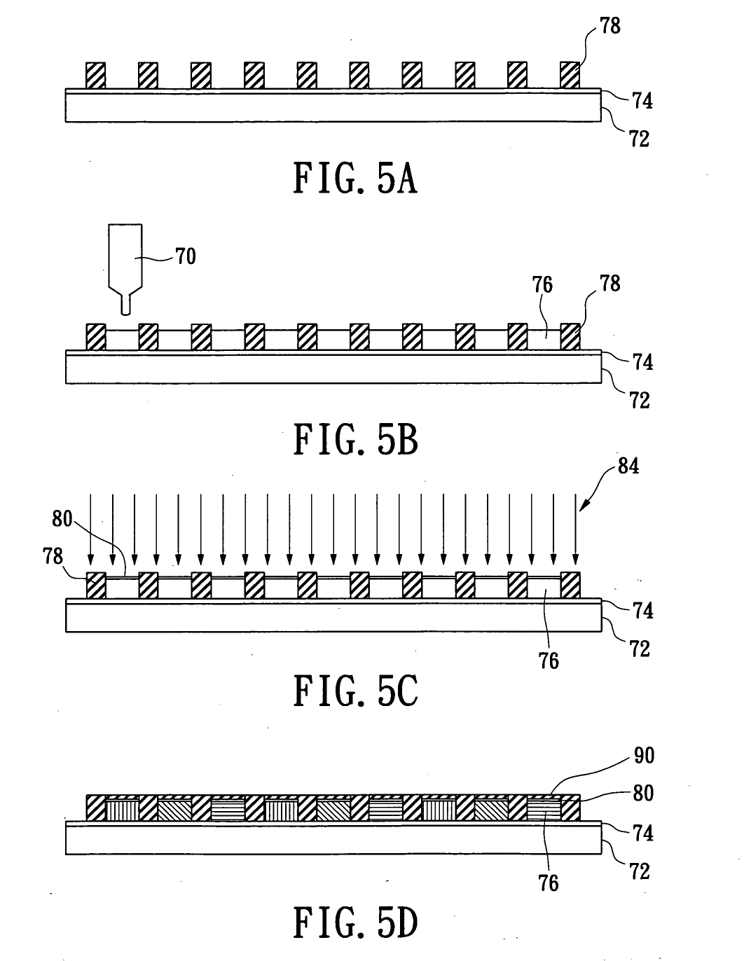

Referring to FIG. 5, the step of combining the upper electrode further comprises the step of using an ink-jet, a screen printing, and/or printing method to coat a plurality of conductive materials 90 on the caps. The conductive materials include inorganic conductive materials or organic conductive materials. After the coating step is completed, the next step can be omitted. As to the steps of the manufacturing process as shown in FIGS. 5A to 5C, the process is identical to that of the first preferred embodiment, and schematic views of the complete structure thereof are shown in FIGS. 5A to 5D, which are schematic views of a color cholesteric liquid crystal display according to a second preferred embodiment of the present invention. The structure is a single layer structure with an overall thinner thickness, and the manufacturing process becomes simpler. The chiral agent is divided into a left chiral agent and a right chiral agent, and there are several different ways for the combination of cholesteric liquid crystals in the cholesteric liquid crystal layer.

If the present color cholesteric liquid crystal display is manufactured in a single-layer full-color display, the cholesteric liquid crystal and the chiral agent are mixed to a blue color first, and then the content of the chiral agent is destroyed by different exposures so as to change the color to green or red, thus achieving the full-color effect. The present invention uses an ink-jet method capable of defining a desired display region, and the ink-jet method is used to fill the liquid crystals into the display region before a full-color effect can be shown. The chiral agent can be divided into a left chiral agent and a right chiral agent. If the right chiral agent is added, the right chiral wavelength will be reflected, and the proportion of the added chiral agent will reflect the wave band. The ink-jet method is advantageously able to control the positioning and introduction of the desired materials into the display region. If it is necessary to define a region, the present invention will design a partition structure and use an ultraviolet ray exposure to simplify the manufacturing process and avoid mixed colors.

While the invention has been described by means of a specification with accompanying drawings of specific embodiments, numerous modifications and variations could be made thereto by those skilled in the art without departing from the scope and spirit of the invention set forth in the claims.

What is claimed is:

1. A method for fabricating a color cholesteric liquid crystal display by ink jet and ultraviolet ray exposure process, said method comprising the step of:
preparing a plurality of partition structures at a first electrode layer of a lower substrate;
coating a plurality of solution layers containing cholesteric liquid crystals and polymer monomers between said partition structures;
forming a plurality of caps on said cholesteric liquid crystals; and
carrying out a process of combining a second electrode layer with said lower substrate.

2. The method of claim 1, wherein said lower substrate uses a glass substrate or a plastic substrate.

3. The method for making a color cholesteric liquid crystal display of claim 1, wherein said first and second electrode layers comprise an active or a passive driving pattern.

4. The method of claim 1, wherein said first and second electrode layers use an inorganic conductive material or an organic conductive material.

5. The method of claim 1, wherein said partition structure is produced by using a lithography, a die-casting, a screen printing and/or an ink-jet process.

6. The method of claim 1, wherein said partition structure is made of a polymer material.

7. The method of claim 6, wherein said polymer material further comprises a pigment or a dye.

8. The method of claim 1, wherein said coating method is achieved by an ink-jet method.

9. The method of claim 1, wherein said caps use an ultraviolet ray exposure method to form a polymer protective layer.

10. The method of claim 1, wherein said cholesteric liquid crystals use a mixed material of a nematic liquid crystal and a chiral agent.

11. The method of claim 1, wherein said cholesteric liquid crystals are a plurality of liquid crystals reflecting different colors.

12. The method of claim 10, wherein said cholesteric liquid crystal has a reflective wavelength ranging from about 400 nm to 800 nm.

13. The method of claim 1, wherein said cholesteric liquid crystal contains a pigment or a dye.

14. The method of claim 1, wherein said cholesteric liquid crystal between said cholesteric liquid crystal layers are combined by a plurality of mutual combinations of left chiral cholesterols and right chiral cholesterols.

15. The method of claim 1, wherein said second electrode layer comprises an upper substrate.

16. The method of claim 15, wherein said process of combining a second electrode layer with said lower substrate further comprises a process of attaching said second electrode layer to said lower substrate.

17. The method of claim 1, wherein said process of combining a second electrode layer and said lower substrate further comprises a process of coating a plurality of conductive materials on said caps as a second electrode layer.

18. The method of claim 17, wherein said conductive material is a black material which absorbs light.

19. The method of claim 17, wherein said coating process can save a combining process to produce a color cholesteric liquid crystal display of a single substrate structure.

20. The method of claim 16, wherein said process of combining said upper and lower substrates directly press said upper and lower substrates or add a glue to said upper and lower substrates for said combining process.

21. The method of claim 15, wherein said process of combining said upper and lower substrates is achieved by an ultraviolet ray exposure process.

22. The method of claim 1 further comprising the step of coating an alignment layer on said first electrode layer of said lower substrate.

23. The method of claim 22, wherein said alignment layer uses polyvinyl alcohol, polyimide, polyamide, nylon, silicon dioxide, micro trench or lecithin.

24. A color cholesteric liquid crystal display, comprising:
a lower substrate, having a first electrode layer;
a plurality of partition structures, dispersed on said lower substrate;
a plurality of cholesteric liquid crystals, dispersed between said partition structures;
a plurality of cap layers, dispersed on said cholesteric liquid crystals; and
a second electrode layer, dispersed on said cap layer.

25. The color cholesteric liquid crystal display of claim 24, further comprising
an alignment layer coated on said first electrode layer of said lower substrate.

26. The color cholesteric liquid crystal display of claim 24, further comprising
a second electrode layer formed on said upper substrate.
